(19) United States
(12) Patent Application Publication
(10) Pub. No.: US 2012/0118081 A1
(43) Pub. Date: May 17, 2012

(54) DEVICE FOR TRANSMITTING TORQUES

(75) Inventors: Andreas EICKE, Isernhagen HB (DE); Joachim Heidemann, Elze (DE)

(73) Assignee: ThyssenKrupp EGM GmbH, Langenhagen (DE)

(21) Appl. No.: 13/102,888

(22) Filed: May 6, 2011

Related U.S. Application Data
(63) Continuation of application No. PCT/EP2009/005966, filed on Aug. 18, 2009.

(30) Foreign Application Priority Data
Nov. 7, 2008 (DE) 10 2008 056 302.1

(51) Int. Cl. G01L 3/10

(52) U.S. Cl. 73/862.335

(57) ABSTRACT

Device for transmitting torques with a torque-transmitting shaft and a bearing block for mounting the shaft. The device includes a measuring device for measuring a torque applied to the torque-transmitting shaft. The measuring device for measuring the torque device is at least partially integrated in the bearing block.

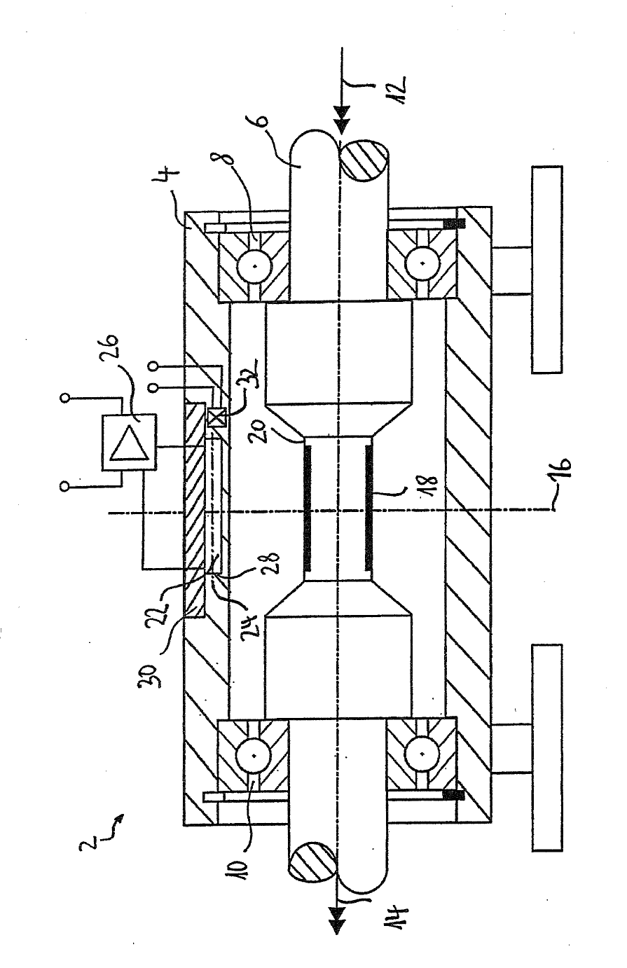

### CROSS-REFERENCE TO RELATED APPLICATIONS

This application is a continuation of application no. PCT/EP2009/005966, filed Aug. 18, 2009, which claims the priority of German application no. 10 2008 056 302.1, filed Nov. 7, 2008, and each of which is incorporated herein by reference.

### FIELD OF THE INVENTION

The invention relates to a device for transmitting torques including a torque-transmitting shaft. More particularly, the invention relates to a device for transmitting torques including a torque-transmitting shaft, a bearing block for mounting the tongue-transmitting shaft, and a measuring device for measuring a torque applied to the torque-transmitting shaft.

### BACKGROUND OF THE INVENTION

Such devices are in particular known in the area of measurement technology where they absorb a torque at their input which they transmit to the output of the device at which the input torque can be received as output torque. For transmitting the input torque to the output of the device, a shaft is used which is rotatably mounted. For mounting the shaft, rolling bearings as well as sliding bearings are used which are configured in such a manner that an efficiency as high as possible is achieved in the device.

When using the device for transmitting torques, first, a torque-transmitting shaft is connected on the input side to a drive which generates a torque. The drive, for example, can consist of a motor or a gear motor combination, wherein different types of motors and gears can be used. Moreover, the input torque of the device can be generated in different manners and is not limited to a torque generation by a motor or a gear motor combination.

In known devices for transmitting torques, an output drive is arranged at the output of the device for transmitting torques, which output drive serves for receiving the torque present at the output of the device. In that case, the output drive can serve for generating a load to which the device is exposed.

In the known devices for transmitting torques, this arrangement serves, for example, for measuring the torques generated by the drive. For this purpose, a measuring device is arranged at the device output of the known devices for transmitting torques so as to detect the torque present at the output of the device and, based on this, draw a conclusion on the torque generated by the drive.

The known devices for transmitting torques include a torque-transmitting shaft, a bearing block for mounting the shaft, and measuring device for measuring a torque applied to the shaft.

However, the devices have the disadvantage that a large space is required for measuring the torque applied to the shaft, whereby efficiency losses and measuring errors can arise which have to be compensated for by comparatively laborious means.

### OBJECTS AND SUMMARY OF THE INVENTION

An object of the invention is to overcome the drawbacks of the prior art.

Another object of the invention is to provide a device for transmitting torques including a torque-transmitting shaft, and which device has a significantly reduced overall size, whereby the required space can be reduced in a corresponding manner.

This object is achieved by the invention set forth herein.

The invention includes a device for transmitting torques including a torque-transmitting shaft, a bearing block for mounting the tongue-transmitting shaft, and a measuring device for measuring a torque applied to the torque-transmitting shaft. The measuring device is at least partially integrated in the bearing block. The torque-transmitting shaft includes an indicator device for indicating a torque applied to the shaft, and the indicator device includes at least one magnetized shaft section.

The invention achieves the underlying object in that the measuring device is at least partially integrated in the bearing block. Thereby it is possible to configure the device much more compact, whereby advantages with respect to overall size and handling of the device are achieved.

According to the invention, the term component is also to be understood as an assembly or a product. Thus, the term component characterizes also an operational connection of different elements, components, assemblies and products.

An advantageous further embodiment of the invention comprises that the shaft has an indicator device for a torque applied to the torque-transmitting shaft. This results in the advantage that the torque applied to the shaft can be measured in a simple manner.

Another advantageous further embodiment of the invention provides that the indicator device has at least one magnetized shaft section. Thereby it is achieved that the torque transmitted by the shaft can be measured directly on the shaft whereby, for example, mechanical disturbance variables can be eliminated. In addition, it is achieved that the components necessary for the measurements can be reduced. Measuring a torque using a magnetized shaft section is known from EP 1 203 209 B1 and EP 1 483 551 B1 and is therefore not discussed here in more detail.

A further advantage is an improved adaptation of the device to the load which acts through the torque to be transmitted on the device. The adaptation of the device to the respective loads can be achieved in a simple manner in that, for example, the torque-transmitting shaft is exchanged with a shaft which is adapted to the loads to be expected. Furthermore, this provides, for example in the case of a defective shaft, the exchange of the same quickly with a new shaft. Thereby, the downtimes of the device, for example due to improper use, can be minimized.

Another advantageous further embodiment of the invention comprises that the magnetized shaft section is long-term or permanently magnetized. This results in the advantage that the shaft has a constant magnetic field, whereby the measurements of the torque transmitted by the shaft can be carried out in cost-effective and sufficiently precise manner.

Further, the bearing block of another advantageous further embodiment has at least one first shaft bearing and at least one second shaft bearing so that the advantageous further embodiment includes that the magnetized shaft section is arranged between first and second shaft bearings. This results in the advantage that in terms of geometrical dimensions, the device can be further reduced, whereby also the handling of the device is improved.

Another advantageous further embodiment of the invention comprises that the magnetized shaft section is arranged equidistant to the first and second shaft bearings. This makes it possible to design the torque-transmitting shaft symmetrically, whereby a simple adjustment and a simplified replacement of the shaft is made possible.

Furthermore, another advantageous further embodiment of the invention comprises that the measuring device has at least one coil for generating a magnetic field which changes when the torque applied to the shaft changes. Applying a torque to the torque-transmitting shaft results in the magnetic field generated by the coil being influenced. This provides a simple manner to determine the torque transmitted by the shaft, whereby a low maintenance device can be implemented. Moreover, in this manner, the device can be calibrated in a simple and cost-effective manner.

A useful further embodiment of the invention comprises that the measuring device has at least one coil amplifier for amplifying the coil power supply signals.

Furthermore, another advantageous further embodiment of the invention provides that the coil amplifier is provided on the bearing block, preferably integrated in the bearing block. In this manner it is possible to carry out the arrangement of the coil amplifiers in the smallest possible space. This provides also the minimizing of the path between coil amplifier and coil, whereby disturbances of the coil power supply signal are significantly reduced.

Moreover, an advantageous further embodiment of the invention provides that the bearing block has at least one holding device for holding at least one coil. This results in the advantage that the arrangement of the coil or the coils can take place in a simple and precise manner so that the effort required for calibrating the device can be reduced.

Further, an advantageous further embodiment of the invention provides that the coil can be removed from the holding device and, particularly, the coil can be removed from the holding device in the assembled state of the bearing block. Thereby it is achieved that the time required for exchanging the coil is considerably reduced. In addition, it is thereby achieved that the device can be adapted in a fast and simple manner to the requirements of the measurement. Further, it is thereby possible to reduce the maintenance times and, moreover, to reduce the maintenance costs.

Moreover, another advantageous further embodiment of the invention provides that the measuring device includes at least one measuring sensor which is integrated in the bearing block. Through the measuring sensor it is possible to determine a measurement valve by which a conclusion can be drawn on the torque transmitted by the shaft. It is advantageous here to use an electronic measuring sensor which provides a computer-assisted recording of the measurand and thus simplifies the subsequent evaluation of the measurement.

Further, another advantageous further embodiment of the invention is characterized in that the measuring sensor is a magnetic field sensor configured for sensing a change of a magnetic field caused by a change of the torque applied to the shaft. In this manner it is achieved that a change of the magnetic field can be measured, by which a conclusion can be drawn as to the torque which is applied to the shaft and which influences the magnetic field. Thereby it is possible to carry out the measurement almost exclusively in an electronic manner, whereby mechanical wear of the device is minimized or excluded. Consequently, the service life of the device is improved.

Moreover, an advantageous further embodiment of the invention provides that the material of the shaft is or contains 50NiCr13 and/or 45CrNiMo16. Through the material selection for the shaft based on the materials described herein, it is achieved that the shaft can be very well adapted to the device requirements. In addition, the shaft is thereby provided with a good machinabilty, whereby the manufacturing costs can be reduced. Further, it was found that the mentioned materials are very well suited for a long-term magnetization of the shaft.

A useful further embodiment of the invention provides that the shaft is through-hardened at least in sections and has in particular at least in sections a hardness of ≧58 HRC according to DIN EN 10109. By hardening the shaft, the mechanical properties for the measurement of the torque are improved, whereby the field of application of the device is extended.

The invention further includes a test stand according to the invention for functional testing of drive trains and/or components of drive trains.

The inventive test stand for functional testing of one of drive trains, components of drive trains, and drive trains of motor vehicles, includes a device for transmitting torques having a torque-transmitting shaft, and a bearing block for mounting the tongue-transmitting shaft. There is a measuring device for measuring a torque applied to the torque-transmitting shaft, and the measuring device is at least being partially integrated in the bearing block, and the torque-transmitting shaft has an indicator device for indicating a torque applied to the shaft, the indicator device including at least one magnetized shaft section.

A use of a device according to the invention in a test stand for functional testing of drive trains and/or components of drive trains, in particular of motor vehicles, is set forth herein.

A method of using the inventive test stand of in accordance with the invention includes functional testing of one of drive trains, components of drive trains, and drive trains of motor vehicles.

The invention is explained in more detail hereinafter by means of the enclosed drawing in which an embodiment of the device according to the invention is illustrated. All features claimed in the patent claims, described and illustrated in the drawing, individually or in any desired combination with each other, form the subject matter of the invention independent of their summary in the patent claims and their dependencies as well as independent of their description or illustration in the drawing.

### BRIEF DESCRIPTION OF THE DRAWINGS

The sole FIGURE of the drawing shows a vertical section through an embodiment of the device in a representation which is reduced in detail.

### DETAILED DESCRIPTION OF THE INVENTION

The illustrated embodiment of device 2 includes a bearing block 4 in which a torque-transmitting shaft 6 is rotatably mounted by a first shaft bearing 8 and a second shaft bearing 10. For the first shaft bearing 8 and the second shaft bearing 10, one grooved ball bearing is used in each case.

The torque-transmitting shaft 6 transmits a drive torque 12 generated by a drive. For a better overview, the drive and the connection of the torque-transmitting shaft 6 to the drive are not illustrated.

The drive torque 12 is transmitted by the torque-transmitting shaft 6 and is output as output torque 14 at the output end of the shaft. To simplify the illustration, the output end of the shaft is likewise not illustrated.

Between the first shaft bearing 8 and the second shaft bearing 10, the torque-transmitting shaft 6 is built symmetrically to a center plane 16. Centered between the first shaft bearing 8 and the second shaft bearing 10, the torque-transmitting shaft 6 has a magnetized shaft section 18, which is arranged in a shaft segment 20. Thus, the magnetized shaft section 18 is arranged equidistant to the first and second shaft bearings 8, 10. Furthermore, a coil 22 which generates an electromagnetic field is arranged in the bearing block 4. The axis 24 of the coil is aligned parallel to the axial direction of the torque-transmitting shaft 6 and is spaced apart from the same. Further, the coil 22 is arranged in such a manner in the bearing block 4 that when loading the torque-transmitting shaft 6, the electromagnetic field generated by the coil 22 is influenced.

A coil amplifier 26 which amplifies the coil power supply signal serves for operating the coil 22. The coil amplifier 26 in turn is connected to a signal source which, for a better overview, is not illustrated.

The coil amplifier 26 is arranged on the bearing block 4 such that it is screwed to the outer surface of the bearing block. For a better overview, the coil amplifier is symbolically illustrated in the FIGURE so that the arrangement of the same on the bearing block is not shown.

In order to be able to remove the coil 22 faster from the bearing block 4, the coil 22 is held in a holding device which is formed so that the bearing block 4 has a recess 28 in which the coil 22 is fastened by use of a cover 30. This provides the exchange of the coil 22 in a non-destructive manner by detaching the cover 30.

For measuring the electromagnetic field which is generated by the coil 22, a measuring sensor is used which is provided in close vicinity to the coil 22. Through the measurement of the electromagnetic field of the coil 22 by use of the measuring sensor it is possible to detect changes of the electromagnetic field of the coil 22. In the illustrated embodiment, the measuring sensor is connected to a computer-assisted evaluating device which, for a better overview of the invention, is not illustrated.

The measuring sensor is formed by a magnetic field sensor 32 by which it is possible to detect the changes of the electromagnetic field due to a change of the magnetic field of the magnetized shaft section 18, and by which change is caused by the applied torque 12.

In the illustrated embodiment, the torque-transmitting shaft 6 is made of the material 50NiCr13. Furthermore, the shaft 6 is through-hardened and has a hardness of 60 HRC according to DIN EN 10109; that is, DIN standard EN 10109.

In this embodiment, the magnetized shaft section 18 has a length of 50 mm, measured in the axial direction of the shaft 6. Further, the shaft segment 20 has an axial length of 60 mm. In this region, the diameter is 40 mm.

The device 2 is not limited to the details described herein. Thus, instead of one coil 22, a pair of coils or a plurality of pairs of coils can be used. There also may be used two pairs of coils which are arranged in radial direction around the magnetized shaft section 18 and are offset with respect to each other by 180°.

Further, the alignment of the coil 22 or the coils can be carried out in different ways so that, for example, the coil axis 24 is provided coaxial to shaft 6.

According to the invention, the device 2 can in particular be part of a test stand for functional testing of drive trains and/or components of drive trains, for example a transmission test stand for functional testing of drives. In such a test stand, the device 2 serves for measuring torques which occur in order to be able to determine whether a component to be tested, for example a transmission, meets predetermined requirements.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. A device for transmitting torques, comprising:
a) a torque-transmitting shaft;
b) a bearing block for mounting the tongue-transmitting shaft;
c) a measuring device for measuring a torque applied to the torque-transmitting shaft;
d) the measuring device at least being partially integrated in the bearing block;
e) the torque-transmitting shaft including an indicator device for indicating a torque applied to the shaft; and
f) the indicator device including at least one magnetized shaft section.

2. The device according to claim 1, which:
a) The magnetized shaft section is long-term magnetized.

3. The device according to claim 1, wherein:
a) The bearing block includes at least one first shaft bearing and at least one second shaft bearing; and
b) the magnetized shaft section is arranged between the first and the second shaft bearings.

4. The device according to claim 3, wherein:
a) the magnetized shaft section is arranged equidistant to the first and the second shaft bearings.

5. The device according to claim 1, wherein:
a) the measuring device includes at least one coil for generating a magnetic field that changes when the torque applied to the shaft changes.

6. The device according to claim 5, wherein:
a) the measuring device includes at least one coil amplifier for amplifying coil power supply signals.

7. The device according to claim 6, wherein:
a) at least one coil amplifier is one of provided on the bearing block, and integrated in the bearing block.

8. The device according to claim 5, wherein:
a) the bearing block includes at least one holding device for holding the at least one coil.

9. The device according to claim 8, wherein:
a) the at least one coil can be one of:
i) removed from the holding device; and
ii) removed from the holding device in the assembled state of the bearing block.

10. The device according to any claim 1, wherein:
a) the measuring device includes at least one measuring sensor which is integrated in the bearing block.

11. The device according to claim 10, wherein:
a) the measuring sensor includes a magnetic field sensor for sensing a change of a magnetic field, and which change is caused by a change of the torque applied to the torque-transmitting shaft.

12. The device according to claim 11, wherein:
a) the material of the shaft includes at least one of 50NiCr13 and 45CrNiMo16.

13. The device according to claim 12, wherein:
a) the shaft is at least in sections through-hardened and includes a hardness of ≧58 HRC according to DIN EN 10109.

14. A test stand for functional testing of one of drive trains, components of drive trains, and drive trains of motor vehicles, the test stand comprising:
a) a device for transmitting torques, including:
b) a torque-transmitting shaft;
c) a bearing block for mounting the tongue-transmitting shaft;
d) a measuring device for measuring a torque applied to the torque-transmitting shaft;
e) the measuring device at least being partially integrated in the bearing block;
f) the torque-transmitting shaft including an indicator device for indicating a torque applied to the shaft; and
g) the indicator device including at least one magnetized shaft section.

15. A method of using the test stand of claim 14, the method includes functional testing of one of drive trains, components of drive trains, and drive trains of motor vehicles.
